(19) United States
(12) Patent Application Publication
(10) Pub. No.: US 2005/0287874 A1
(43) Pub. Date: Dec. 29, 2005

(54) Plugging structure of electric connector

(76) Inventors: Stan Cheng, Taipei (TW); Chen Shih-Tsung, Taipei (TW)

Correspondence Address: Yi-Wen Tseng, 4331 Stevens Battle Lane, Fairfax, VA, 22033, US

(21) Appl. No.: 10/875,170

(22) Filed: Jun. 25, 2004

(51) Int. Cl. H01R 13/432

(52) U.S. Cl. 439/746

(57) ABSTRACT

A large-area heat dissipation structure has a thermal conducting member and a heat sink assembly. The thermal conducting member has a large-area thermal conductive plate and a thermal conductive base protruding from a lower surface of the large-area thermal conductive plate. The heat sink assembly has a plurality of fins mounted to an upper surface of the thermal conducting member. A plurality of support members extends downwardly from the lower surface of the large-area thermal conductive plate.

### BACKGROUND OF THE INVENTION

The present invention relates in general to a plugging structure of an electric connector, and more particularly, to an electric connector having a handle allowing the electric connector to be easily connected or disconnected.

Computers have gradually become necessary appliances in our daily lives. Particularly, many users enjoy assembling components themselves. The problem for self-assembled computers is that to avoid loose or detached due to external force or vibration, the connectors in the computers are normally too tight to replace. When the computer is short of space for operation or replacement, the user is easily hurt.

One of the most commonly used connectors in the computer includes the insulation displacement connector such as ATA connector, or the serial ATA connector, which has become the mainstream connector currently. FIG. 1 shows an ATA connector 10a which includes an insulation body 101a and a cover 102a. A narrow slit 103a is formed between insulation body 101a and the cover 102a allowing a paper tab 104a to extend through. As shown in FIG. 2, the paper tab 104a and the ribbon cable 105a are clipped to the insulation body 101a. The ATA connector 10a can be easily removed from the socket by pulling the paper tab 104a from the ATA connector 10a. Another type of connector as shown in FIG. 3 uses a lift bar 106 instead of the paper tab 104a.

However, in the above structures, it is very often that paper tab 104a will be removed during the pulling process, such that original assisting function is lost. In addition, installation the lift bar 106a increases the height of the ATA connector 10a to affect assembly of other devices. Both of the paper tab 104a and the lift bar 106a provide removal function of the ATA connector 10a only. Neither of them assists in plug-in operation.

### BRIEF SUMMARY OF THE INVENTION

The present invention is to provide an electric connector with an insulation body and a cover. The insulation body has a pair of opposing elongate surfaces and two end surfaces between the elongate surfaces. The elongate surfaces and the end surfaces form a space in which a plurality of conductive terminals are embedded. The cover has a handle and a pair of opposing side surfaces extending from two elongate edges of the handle. 6. The handle includes a cylindrical stick topped with a spherical member. The interior surface of the side surfaces has a locking mechanism, such that when the insulation body is inserted into the side surfaces of the cover, the insulation body can be secured within the cover. The handle has a curved top portion and a recessed lower portion with rough surfaces thereon, such that the user can easily plug the connector in a socket or remove the connector from the socket by pushing and pulling the handle.

Alternatively, the handle may have a flat top surface and two curved recessed side rough surfaces or a flat top surface and two flat rough surfaces. In another embodiment, the handle may be in the form of a stick topped with a spherical member.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The above objects and advantages of the present invention will be become more apparent by describing in detail exemplary embodiments thereof with reference to the attached drawings in which:

FIG. 1 is a perspective view of a conventional electric connector;

FIG. 2 is a perspective view of another type of conventional electric connector;

FIG. 3 is a perspective view of another conventional electric connector;

FIG. 4 is an exploded view of an electric connector provided by the present invention;

FIG. 5 is a perspective view of the electric connector;

FIG. 6 shows a second embodiment of the electric connector;

FIG. 7 shows a third embodiment of the electric connector;

FIG. 8 shows a fourth embodiment of the electric connector; and

FIG. 9 shows a fifth embodiment of the electric connector.

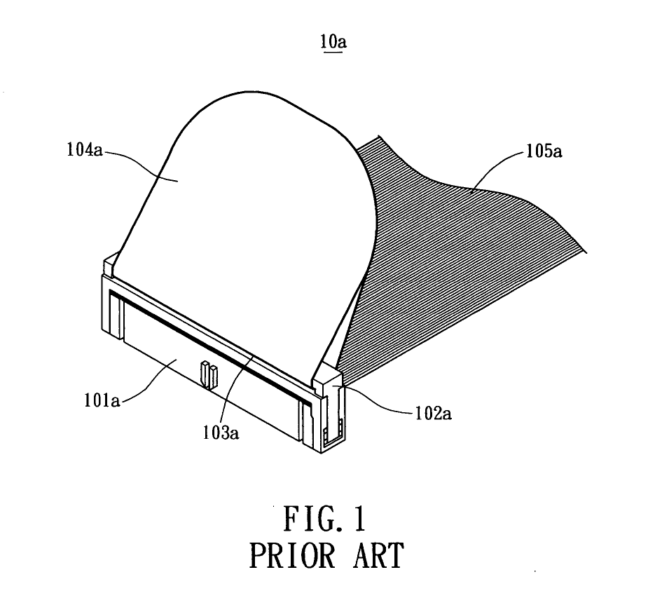

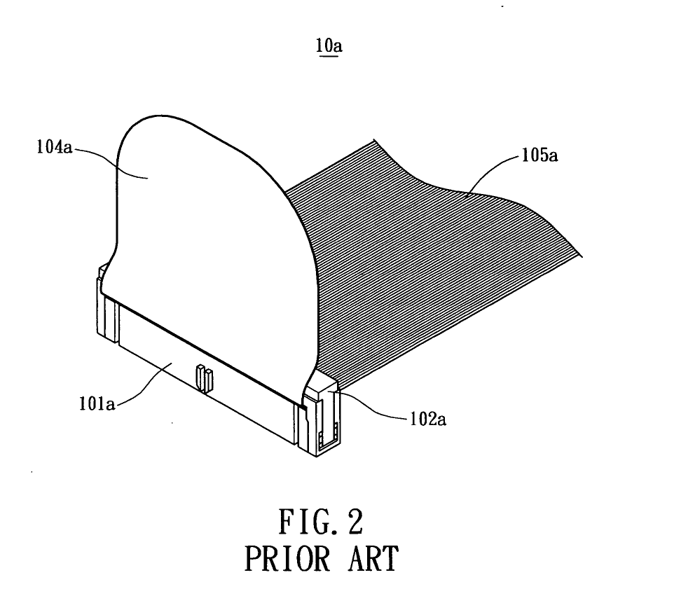

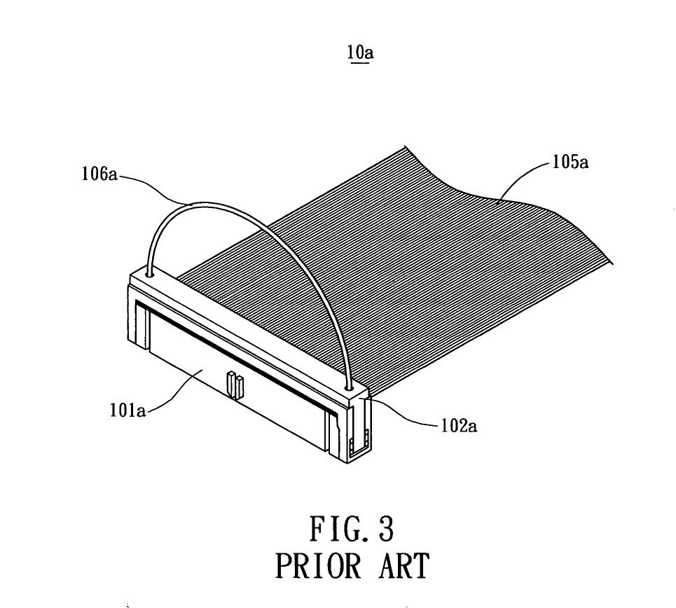

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

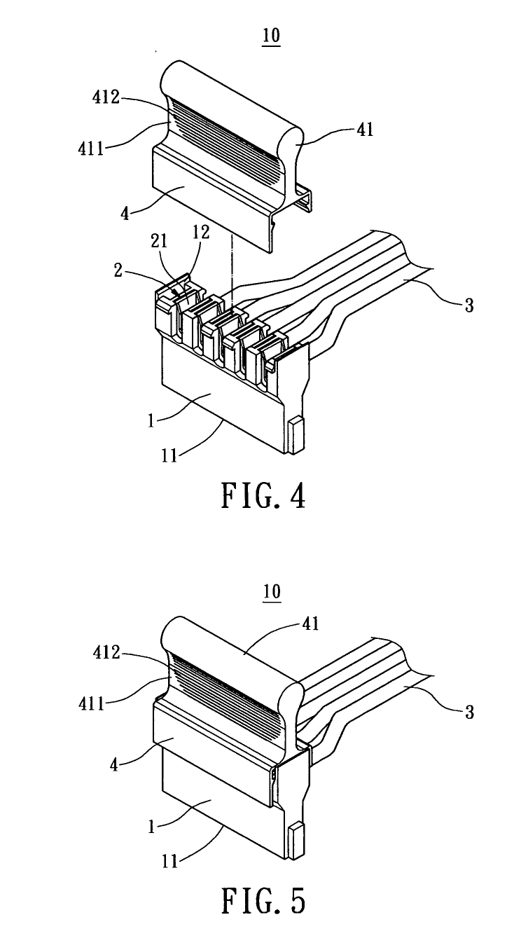

As shown in FIG. 4, the connector 10 is a serial ATA connector including an insulation body 1 having a pair of opposing elongate surfaces 11 and pair of end surfaces 12 between the elongate surfaces 11. The elongate surfaces 11 and the end surfaces 12 form a rectangular space in which a plurality of conductive terminals 2 are installed. Preferably, the end surfaces 12 extend over the elongate surfaces 11, and the conductive terminals 2 extend to the same level of the end surfaces 12. Each of the conductive terminals 2 includes a base split into a connection part and a piercing part 21. The connection parts (not shown) are located at the elongate surfaces 11, while the piercing parts 21 extend to the same level of the end surfaces 12. In addition, the piercing parts 21 are connected to a ribbon cable 3.

The connector 10 further includes a cover 4 having handle 41 and two elongate surfaces extending downward from two elongate edges of the handle 41. The handle 41 and the elongate surfaces form a space for receiving the protruding portions of the conductive terminals 2 therein, such that the conductive terminals 2 can be enclosed within the elongate surfaces of the cover 4 and the end surfaces 12 of the insulation body 1. Preferably, the handle 41 has a curved top portion allowing the user to hold it by one hand, and a lower recess portion 411 with a rough surface 412, such that the user can easily grab the handle 41 at the recess portion 411.

As shown in FIG. 5, to assemble the electric connector 10, the lower portions of the conductive terminals 2 are inserted into the insulation body 1, while the piercing portions 21 extend between the side surfaces 12 and connect to the ribbon cable 3. The insulation body 1 is then covered with the cover 4. Preferably, the internal surface of the elongate surfaces of the cover 4 has a locking mechanism for locking the cover 4 with the insulation body 1.

To plug the electric connector 10 in a socket, the user only need to hold the handle 41 of the cover 4, and align and press the electric connector 10 against the socket. To remove the electric connector 10 from the socket, the user can simply pull the electric connector 10 at the handle 41 upwardly.

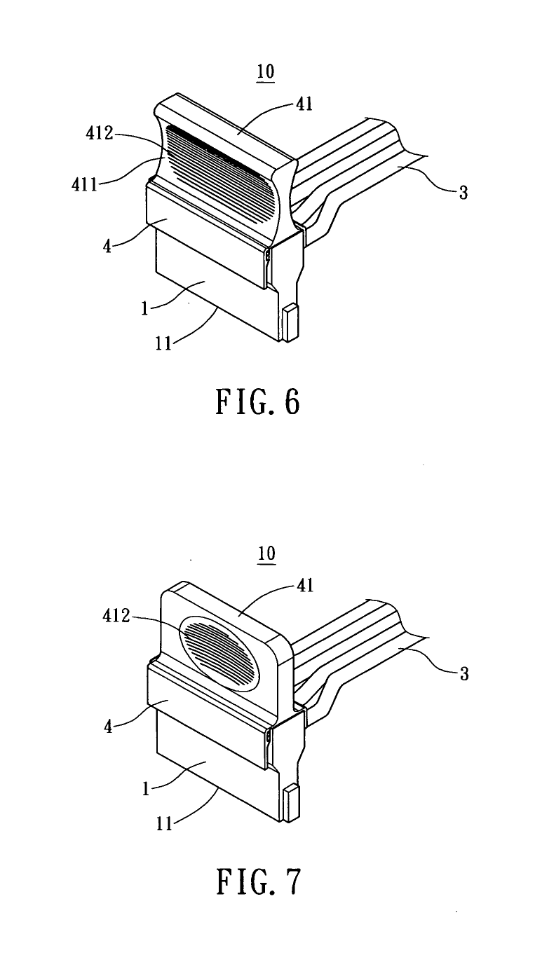

In addition to the curved top portion as shown in FIG. 5, the top portion of the handle 41 can also be a flat surface as shown in FIG. 6.

FIG. 7 shows another embodiment of the handle 41. As shown in FIG. 7, the handle 41 has two flat rough surfaces 412 instead of curved or recessed surfaces. The top surface of the handle 41 is also flat in this embodiment.

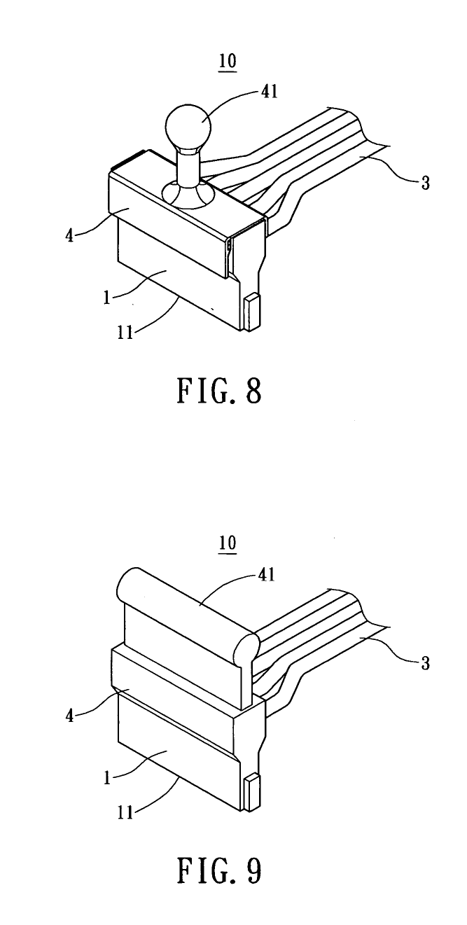

In FIG. 8, the handle 41 is in the form of a cylindrical stick 421 having a spherical top. The diameter of the spherical top is larger than the diameter of the cylindrical stick 421.

In FIG. 9, the handle 41 is in the form of an elongate plate and an elongate cylinder on top of the elongate plate.

The above electric connector 1 uses various types of cover 4 having a handle 41 allowing user to easily hold the connector 1, so as to plug the electric connector 10 in a socket or remove the electric connector 10 from the socket.

While the present invention has been particularly shown and described with reference to preferred embodiments thereof, it will be understood by those of ordinary skill in the art the various changes in form and details may be made therein without departing from the spirit and scope of the present invention as defined by the appended claims.

1. An electric connector, comprising:
an insulation body, having a pair of opposing elongate surfaces and a pair of end surfaces between the elongate surfaces, the elongate surface and the end surfaces forming a rectangular space;
a plurality of conductive terminals disposed in the space, each having a piercing part extending over the elongate surfaces;
a cover, having an elongate covering member with two open ends and a handle extending upwardly from a top of the elongate covering member, wherein the elongate covering member has a locking mechanism in an interior surface thereof for locking with each piercing part so that the conductive terminals ar enclosed therein.

2. The connector of claim 1, wherein the cover and the insulation body are integrally formed.

3. The connector of claim 1, wherein the handle has a curved top portion and a recessed lower portion with rough surfaces thereon.

4. The connector of claim 1, wherein the handle has a flat top surface and two curved recessed side rough surfaces.

5. The connector of claim 1, wherein the handle has a flat top surface and two flat rough side surfaces.

6. The connector of claim 1, wherein the handle includes a cylindrical stick topped with a spherical member.

7. The connector of claim 1, wherein the end surfaces of the insulation body extends over the surfaces.

8. The connector of claim 7, wherein each piercing portion of the conductive terminals has the same level with the end surfaces of the insulation body such that the conductive terminals are enclosed within the elongate covering member and the end surfaces.
